(19) United States
(12) Patent Application Publication
(10) Pub. No.: US 2008/0313550 A1
(43) Pub. Date: Dec. 18, 2008

(54) RECORDING MEDIUM ON WHICH Web CONFERENCE SUPPORT PROGRAM IS RECORDED AND Web CONFERENCE SUPPORT APPARATUS

(75) Inventors: Koichi SHIGA, Kawasaki (JP); Yuji Hashimoto, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/044,474

(22) Filed: Mar. 7, 2008

(30) Foreign Application Priority Data
Jun. 15, 2007 (JP) JP2007-158308

(51) Int. Cl. G06F 3/00

(52) U.S. Cl. 715/753

(57) ABSTRACT

A Web conference support apparatus acquires arbitrary attribute information from attribute information of a user, specifies a related video conference data file having information related to the attribute information in a set of video conference data files of a Web conference, forms link information which accesses the related video conference data file specified and a start command of a new Web conference between a participant in a related Web conference related to the related video conference data file and the user, and embeds the link information and the start command in Web page information which can accept selection of the related video conference data file and the new Web conference. The Web page information is transmitted to a terminal device of the user.

### CROSS-REFERENCE TO RELATED APPLICATIONS

This application is related to and claims priority to Japanese patent application no. 2007-158308 filed on Jun. 15, 2007 in the Japan Patent Office, and incorporated by reference herein.

### BACKGROUND

### 1. Field

The embodiments relate a computer readable recording medium on which a Web conference support program supporting a Web conference held by a Web conference system between terminal devices is recorded, a Web conference support apparatus, and a Web conference support method.

### SUMMARY

According to an aspect of an embodiment, a Web conference support system is provided by acquiring arbitrary attribute information from attribute information of a user; specifying a related video conference data file having information related to said acquired attribute information in a set of video conference data files of a Web conference; forming link information which accesses said related video conference data file specified by said specifying and a start command of a new Web conference between a participant in a related Web conference related to said related video conference data file and said user; embedding said formed link information and said start command in Web page information accepting selection of said related video conference data file and said new Web conference; and transmitting said Web page information to a terminal device of said user.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a system configuration diagram of a Web conference system according to an embodiment;

FIG. 2 is an explanatory diagram showing a hardware configuration of a server and a terminal device;

FIG. 3 is an explanatory diagram showing a data configuration of a video conference data file;

FIG. 4A is an explanatory diagram (part 1) showing an example of conference additional information of the video conference data file;

FIG. 4B is an explanatory diagram (part 2) showing an example of conference additional information of a video conference data file;

FIG. 5 is an explanatory diagram showing a reference table of a conference DB;

FIG. 6 is an explanatory diagram showing an example of a user interface screen display in a terminal device;

FIG. 7 is an explanatory diagram showing an example of a user interface conference screen;

FIG. 8 is an explanatory diagram showing an example of a user interface Web screen;

FIG. 9 is an explanatory diagram showing a storage content of a user DB;

FIG. 10 is a block diagram showing functional configuration 1 of a Web conference support apparatus according to an embodiment;

FIG. 11A is an explanatory diagram (part 1) showing specifying of a related video conference data file;

FIG. 11B is an explanatory diagram (part 2) showing specifying of the related video conference data file;

FIG. 12 is an explanatory diagram showing a related information table;

FIG. 13 is a flow chart showing an updating procedure of the related information table;

FIG. 14 is a flow chart showing a Web conference support procedure according to an embodiment;

FIG. 15 is an explanatory diagram showing a video conference data file having a browsing authority and a browsing deadline;

FIG. 16 is an explanatory diagram showing a user interface display screen on a terminal device of a user Y which does not belong to the global group G1;

FIG. 17 is an explanatory diagram showing a user interface display screen of a terminal device of a user X which belongs to the global group G1;

FIG. 18 is a block diagram showing functional configuration 2 of a Web conference support apparatus according to an embodiment;

FIG. 19 is an explanatory diagram showing a user interface presence screen when a holding notification is received;

FIG. 20 is an explanatory diagram showing a user interface presence screen of a user X who is an organizer after a holding notification is transmitted;

FIG. 21 is an explanatory diagram showing a new user interface Web screen after the user interface Web screen shown in FIG. 10 is updated; and

FIG. 22 is a flow chart showing a Web conference support procedure in a functional configuration 2 of the Web conference support apparatus.

### DETAILED DESCRIPTION OF THE PREFERRED EMBODIMENTS

A conventional Web conference system in which users located in various places can hold a conference on a network has been proposed. In such a Web conference system, each user chats through a terminal device, freely writes on an interactive board, or engages in speech conversation. Furthermore, a camera is installed in a terminal device to make it possible to display a video image of each user on a screen of a terminal device of another user. The contents of the Web conference are recorded. The user accesses the Web conference system to check the contents.

However, when a video file of a video conference is to be converted into an article (Web page information) by an information transmitting apparatus such as a blog server, the article must be associated with another article or another video file by human decision. Furthermore, when multimedia data such as a video file of a conference is used, the conference data are sequentially reproduced by a user, so that the user must recognize and associate the contents. For this reason, since formation of related articles including multimedia data such as a video file of a conference strongly depends on subjective association of a user who posts the article, objective association is difficult to be obtained.

When a user who is interested in the posted article which is posted as described above wants to communicate with persons related to the article, the user herself/himself must search for the persons related to the article and take action such as another telephone call or mail transmission.

In this manner, multimedia data contents such as video files of a Web conference are only classified into a library by the poster subjectively, and new communication based on the library contents is separated.

An embodiment will be described below in detail with reference to the accompanying drawings.

(System Configuration of Web Conference System)

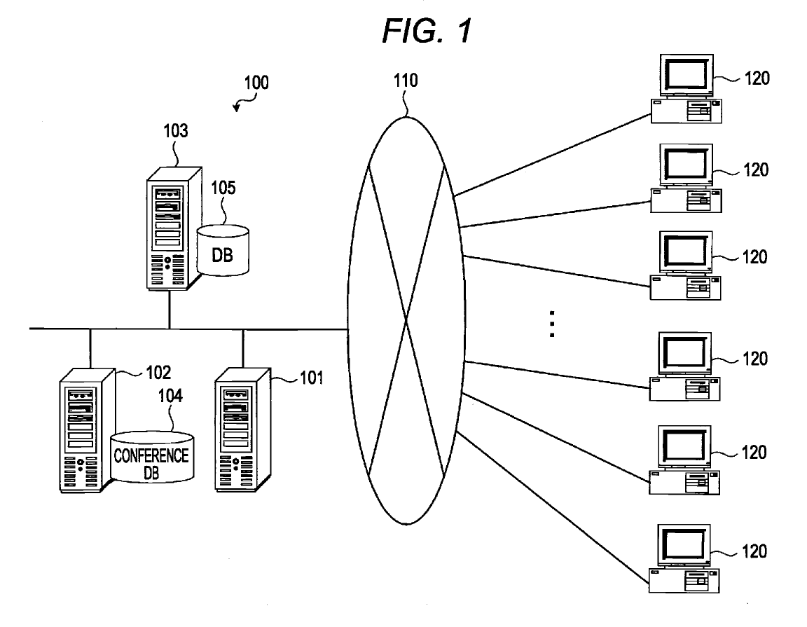

FIG. 1 is a system configuration diagram of a Web conference system. A Web conference system 100 is connected to terminal devices 120 through a network 110 such as the Internet such that the Web conference system 100 can communicate with the terminal devices 120. The terminal devices 120 hold Web conferences with each other.

Each of the terminal devices 120 is a computer device which is used by each user in a Web conference. In the terminal device 120, message client software, conference client software, and a Web browser are installed. The message client software is an application which displays presence information (for example, “on one's seat”, “in conference”, or “leave one's seat”) expressing a state of the user of the terminal device 120. When the message client software is started, as a user interface the presence information is displayed on a screen of the terminal device 120 of a user who becomes a participant in a Web conference. The conference client software is an application which holds a Web conference. When the conference client software is started, as a user interface a conference screen is displayed on the screen of the terminal device 120 of a user who becomes a participant in the Web conference. The Web browser is an application which analyzes Web page information to display as a user interface the contents of the information on a screen.

The Web conference system 100 is structured such that a presence management apparatus 101, a conference service apparatus 102, and a Web conference support apparatus 103 are connected to each other, communicating with each other. The presence management apparatus 101 is a server which manages presence information of all the users. The conference service apparatus 102 is a server which controls a Web conference when a holding request of the Web conference is accepted.

The conference service apparatus 102 includes a conference DB 104 which stores a video conference data file group obtained by recording Web conferences which has been held in the past. Therefore, when the conference service apparatus 102 accepts a designation of reproducing a video conference data file related to a certain Web conference from the terminal device 120, the conference service apparatus 102 transmits the Web conference to the terminal device 120.

The Web conference support apparatus 103 includes a user DB 105 which stores attribute information of a user. The Web conference support apparatus 103 is a server which operates together with the presence management apparatus 101 and the conference service apparatus 102 to distribute Web page information to the terminal device 120. The Web conference support apparatus 103 functions to notify a user of a Web conference related to a Web conference in which the user participates following a rule base. Detailed processes of the Web conference support apparatus 103 will be described later.

The presence management apparatus 101, the conference service apparatus 102, and the Web conference support apparatus 103 are arranged as separate servers. However, any two of the apparatuses may be put together into one server, or all the apparatuses may be put together into one server.

(Hardware Configuration of Server 101 to 103 and Terminal Device 120)

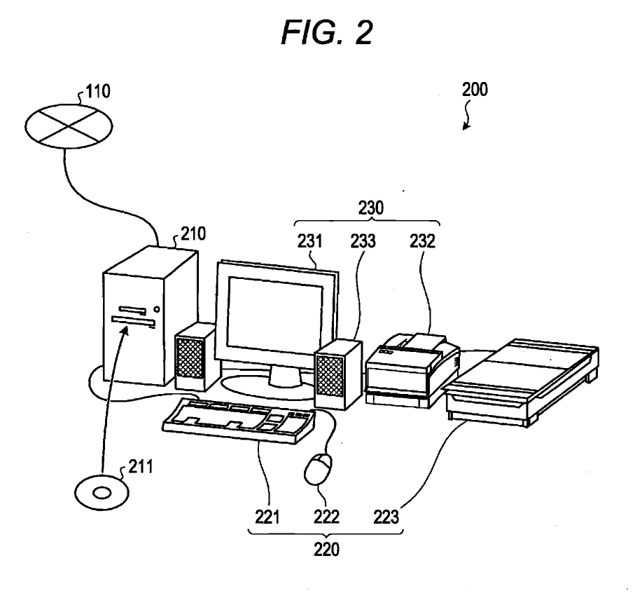

A hardware configuration of the servers 101 to 103 and the terminal device 120 will be described below. FIG. 2 is an explanatory diagram showing a hardware configuration of the servers 101 to 103 and the terminal device 120.

Each of the servers 101 to 103 and the terminal device 120 is constituted by a computer main body 210, an input device 220, and an output device 230, and can be connected to the network 110 such as a LAN or a WAN through a router or a modem (not shown).

The computer main body 210 has a CPU, a storage device, and an interface. The CPU entirely controls the server and the terminal device 120. The storage device is constituted by a ROM, a RAM, an HD, an optical disk 211, and a flash memory. The RAM is used as a work area for the CPU.

Various programs are stored in the storage device and are loaded depending on an instruction from the CPU. Read/write control of data on the HD and the optical disk 211 is controlled by a disk drive. The optical disk 211 and the flash memory can be freely attached to or detached from the computer main body 210. The interface controls input from the input device 220, output to the output device 230, and transmission/reception to the network 110.

As the input device 220, a keyboard 221, a mouse 222, a scanner 223, or the like is used. The keyboard 221 has a key to input characters, numbers, various designations, and the like to input data. The input device 220 may be of a touch panel type. The mouse 222 moves a cursor, selects a range, moves a window, or changes a size. The scanner 223 optically reads an image. The read image is captured as image data and stored in a storage device in the computer main body 210. An OCR function may be given to the scanner 223.

As the output device 230, a display 231, a printer 232, a loudspeaker 233, or the like. The display 231 displays an interactive user interface, starting with a cursor, icon or a tool box, data such as a document, an image, and functional information. The printer 232 prints image data or document data. The loudspeaker 233 outputs voice such as sound effects or read-out sound.

(Video Conference Data File)

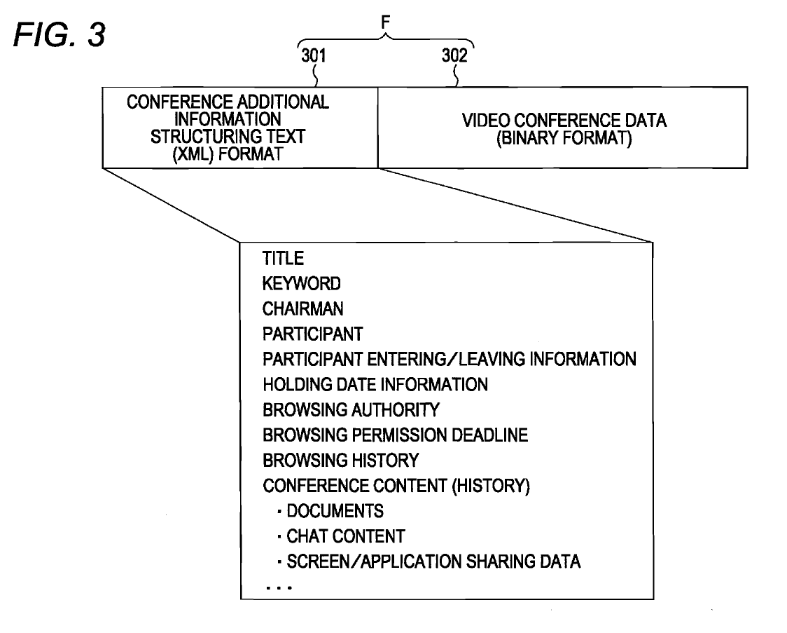

A data configuration of a video conference data file will be described below. FIG. 3 is an explanatory diagram showing a data configuration of a video conference data file. In FIG. 3, a video conference data file F is constituted by a conference additional information 301 and a video conference data 302. The conference additional information 301 is formed by a structuring text (XML) format. As the conference additional information 301, in an unlimiting example, a title, a keyword, a chairman (lecturer), a participant, participant entering/leaving information, holding data information, a browsing authority, a browsing permission deadline, a browsing history, a conference content (for example, documents, chat content, and screen/application software sharing data) of the Web conference are described. The video conference data 302 is data of a binary format, and content data expressing a content of the Web conference. The video conference data file is stored in the conference DB 104 of the conference service apparatus 102.

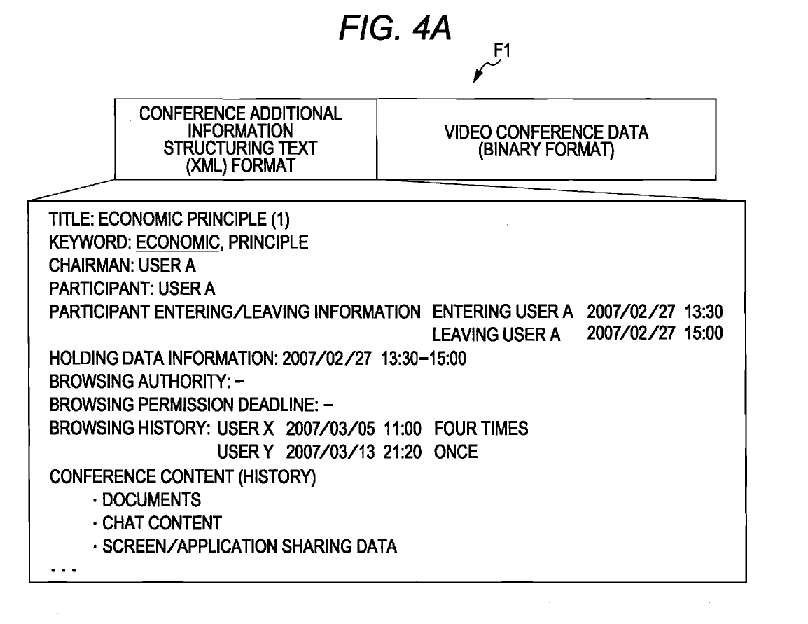

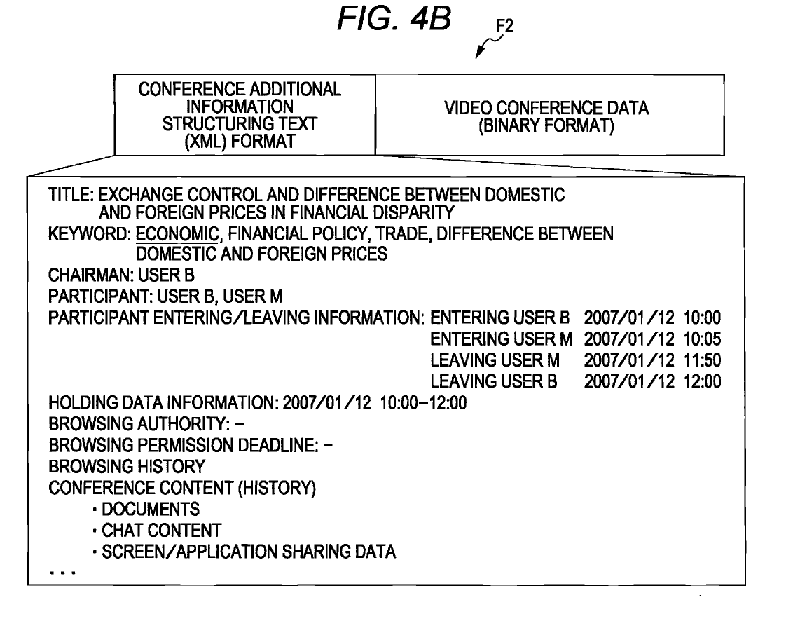

FIGS. 4A and 4B are explanatory diagrams showing an example of the conference additional information 301 of the video conference data file F. FIG. 4A shows a video conference data file F1 related to a Web conference (lecture) of “Economic Principle (1)”. FIG. 4B shows a video conference data file F2 related to a Web conference (lecture) of “Exchange Control and Difference between Domestic and Foreign Prices in Financial Policy”.

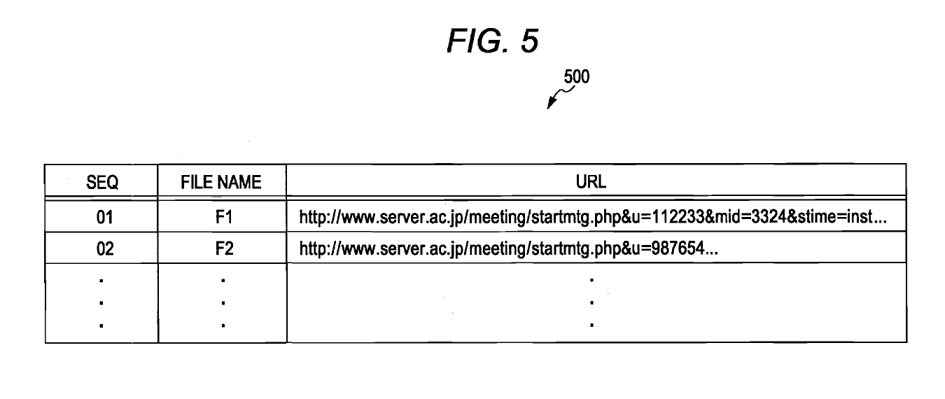

FIG. 5 is an explanatory diagram showing a reference table of the conference DB 104. In a reference table 500, a file name of the video conference data file F and a URL specifying a storage location in the conference DB 104 are associated with each other. The file name of the video conference data file F are designated by the reference table 500, so that the video conference data file F can be called up by using the corresponding URL as a clue.

(Example of Screen Display in Terminal Device 120).

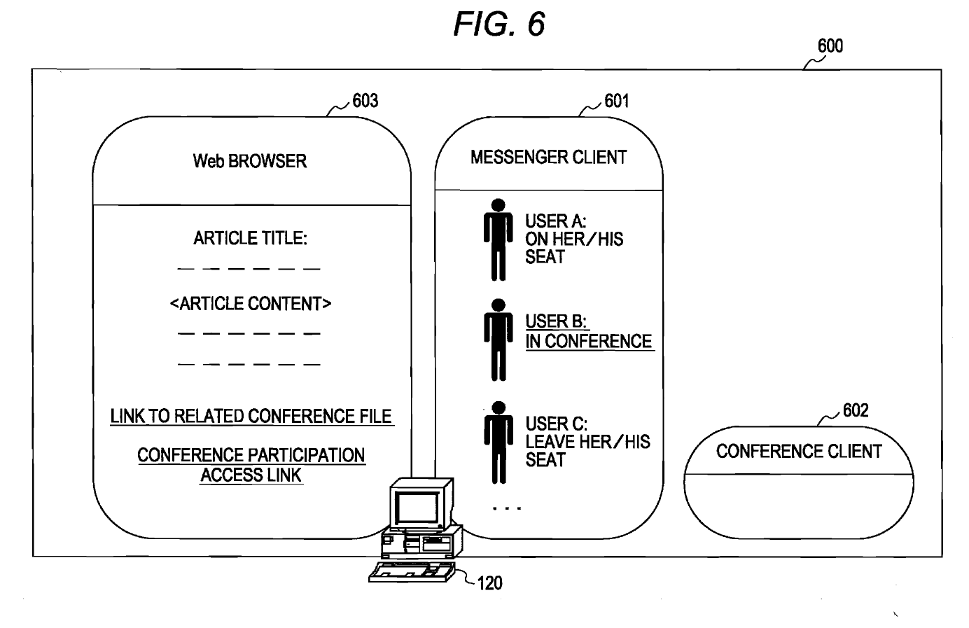

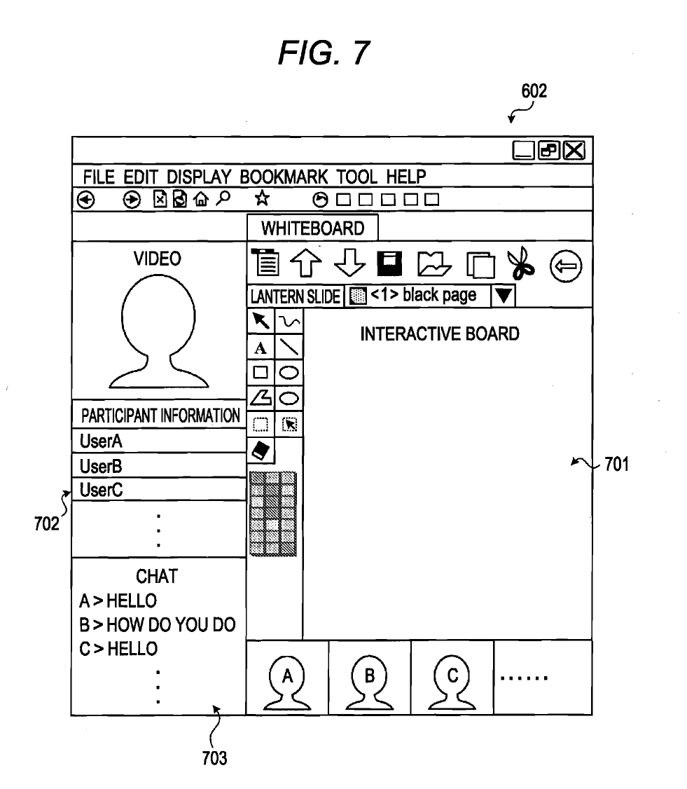

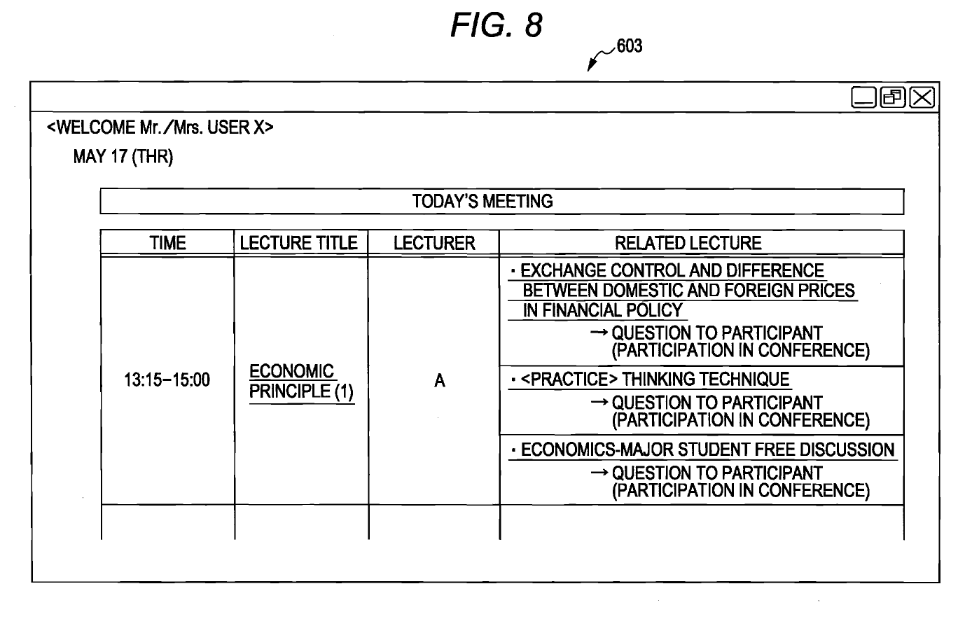

An example of screen display in the terminal device 120 will be described below. FIG. 6 is an explanatory diagram showing an example of the screen display in the terminal device 120. In FIG. 6, on a user interface display screen 600, a presence screen 601 obtained by message client software, a conference screen 602 obtained by conference client software, and a Web screen 603 obtained by a Web browser are displayed. On the presence screen 601, a state of a user is displayed on real time. The details of the conference screen 602 will be described in FIG. 7. The details of the Web screen 603 will be described in FIG. 8.

FIG. 7 is an explanatory diagram showing an example of the user interface conference screen 602. The conference screen 602 includes an interactive region 701, a display region 702 of participant information, and a chat region 703. The interactive region 701 is a region on which documents can be uploaded or in which characters or graphics can be written. The display region 702 of the participant information is a region in which information of a user who participates in the Web conference is displayed. The chat region 703 is a region in which participants chat with each other.

FIG. 8 is an explanatory diagram showing an example of the user interface Web screen 603. On the Web screen 603, a schedule of a user X is displayed. In the example mentioned here, the user X is a student attending “Economic Principle (1)” as a Web conference, and a lecturer A is a professor. On this day (May 17), the user X plans to attend “Economic Principle (1)” from 13:15 to 15:00. In a character string of “Economic Principle (1)”, link information is embedded. When “Economic Principle (1)” is clicked, the URL of the “Economic Principle (1)” is transmitted to the conference service apparatus 102, and the video conference data file F1 of “Economic Principle (1)” is reproduced on the conference screen 602 by the conference client software.

On the Web screen 603, related lectures are listed. The related lecture is Web conferences related to the Web conference (here, “Economic Principle (1)”) and automatically associated by a rule base in the Web conference support apparatus 103. Link information is also embedded in a character string of the related conference. For example, when “Exchange Control and Difference between Domestic and Foreign Prices in Financial Policy” is clicked, the URL of the “Exchange Control and Difference between Domestic and Foreign Prices in Financial Policy” is transmitted to the conference service apparatus 102, and the video conference data file F2 of the “Exchange Control and Difference between Domestic and Foreign Prices in Financial Policy” is reproduced on the conference screen 602 by the conference client software.

(Storage Content of User DB 105)

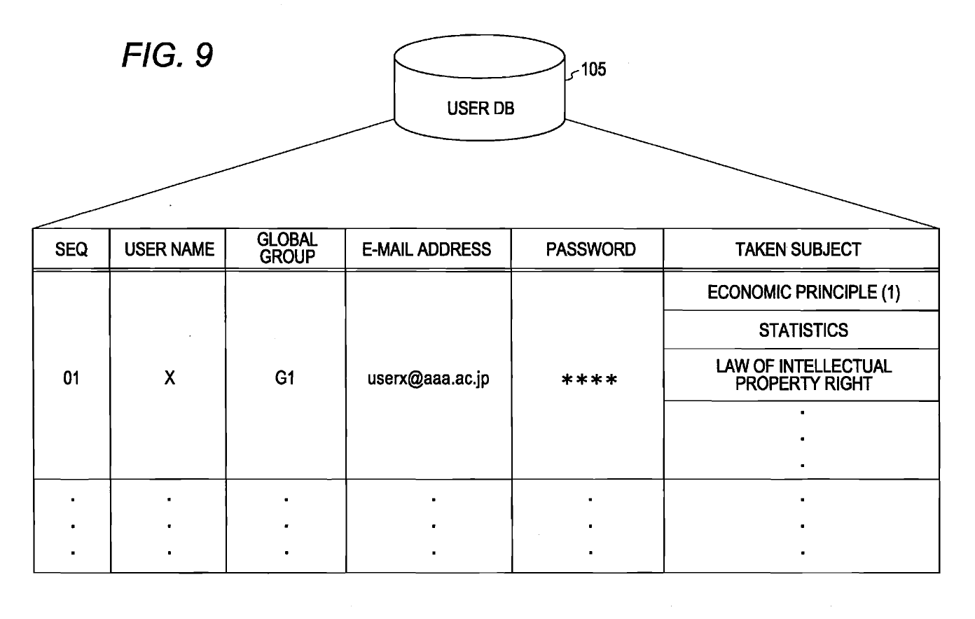

A storage content of the user DB 105 will be described below. FIG. 9 is an explanatory diagram showing the storage content of the user DB 105. The user DB 105 stores user names, global groups, e-mail addresses, passwords, and taken subjects for each user. The user name is a name which specifies a user, and may be a name or a handle name. The global group is a group to which a user belongs. In the Web conference, browsing restrictions may be set in units of groups. For this reason, when the browsing restriction is to be set, the global group must be checked.

The e-mail address is an address which can be used in chat in a Web conference. The password is a password required when a user logs in on the Web screen. The taken subject is a list of lectures (Web conference) which a user attends, and is handled as attribute information inherent in the user.

(Functional Configuration 1 of Web Conference Support Apparatus 103)

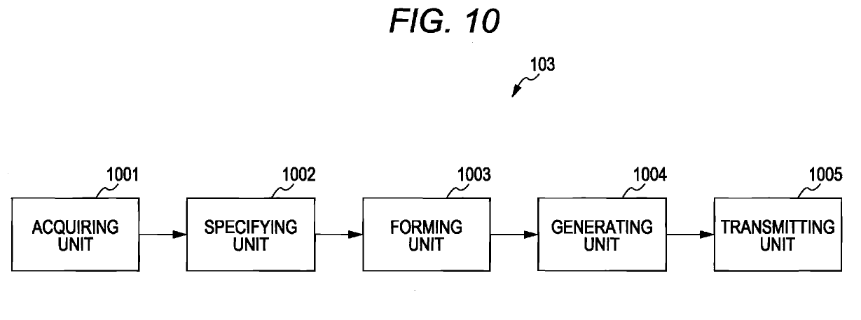

A functional configuration 1 of the Web conference support apparatus 103 according to an embodiment will be described below. FIG. 10 is a block diagram showing the functional configuration 1 of the Web conference support apparatus 103. In FIG. 10, the Web conference support apparatus 103 includes an acquiring unit 1001, a specifying unit 1002, a forming unit 1003, a generating unit 1004, and a transmitting unit 1005.

Each of the configurations 1001 to 1005 causes the CPU to execute a program stored in the memory. Output data from each configuration is stored. A configuration to be accessed indicated by an arrow in FIG. 10 loads output data from a source configuration and causes the CPU to execute a program related to the configuration.

The acquiring unit 1001 has a function of acquiring arbitrary attribute information from attribute information of a user. In this case, the attribute information is information specific to a user and stored in the user DB 105. In the user DB 105 shown in FIG. 9, a taken subject corresponds to the attribute information. The attribute information to be acquired may be all character strings or some of the character strings representing the attribute information.

For example, when the taken subject is “Economic Principle (1)”, “Economic Principle (1)” may be directly acquired, and “Economic Principle” may be acquired. Alternatively, a word such as “Economic” or “Principle” having a meaning may be cut.

A timing of the acquisition may be set such that re-acquisition may be performed each time a predetermined period of time has elapsed or such that re-acquisition may be performed each time screen transition of the Web screen 603 occurs. In this manner, regardless of the intention of a user, the attribute information can be changed at random.

The specifying unit 1002 has a function of specifying a video conference data file (to be referred to as a “Related Video Conference Data File”) having information related to the attribute information acquired by the acquiring unit 1001 from a set (conference DB 104) of the video conference data files F of the Web conference.

The data of the conference DB 104 used to specify the video conference data file may be regulated by a predetermined rule base. For example, the video conference data file F which has not been reproduced by a user may be set as target data of the video conference data file F serving as a specifying source. The video conference data file F which has been browsed a predetermined number of times or more may be set as target data of the video conference data file F. Furthermore, the video conference data file F the browsing authority of which is held by the user or the video conference data file F the browsing deadline of which has not passed may be set as target data of the video conference data file F.

In this case, the related video conference data file will be described below. The related video conference data file is a video conference data file F having information related to the attribute information acquired by the acquiring unit 1001. More specifically, when the information related to the attribute information acquired by the acquiring unit 1001 is included in the conference additional information 301, a related video conference data file is used.

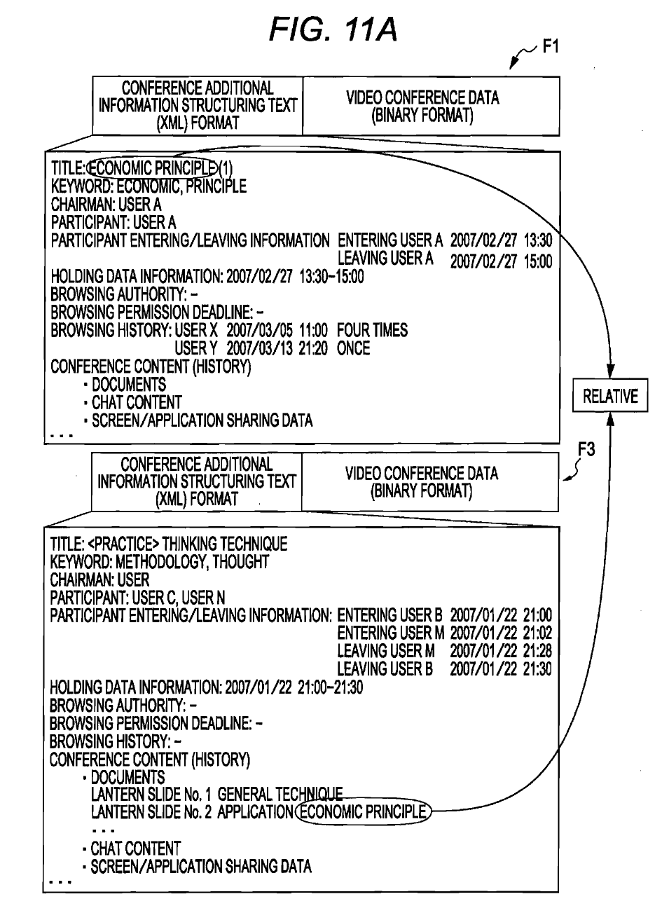

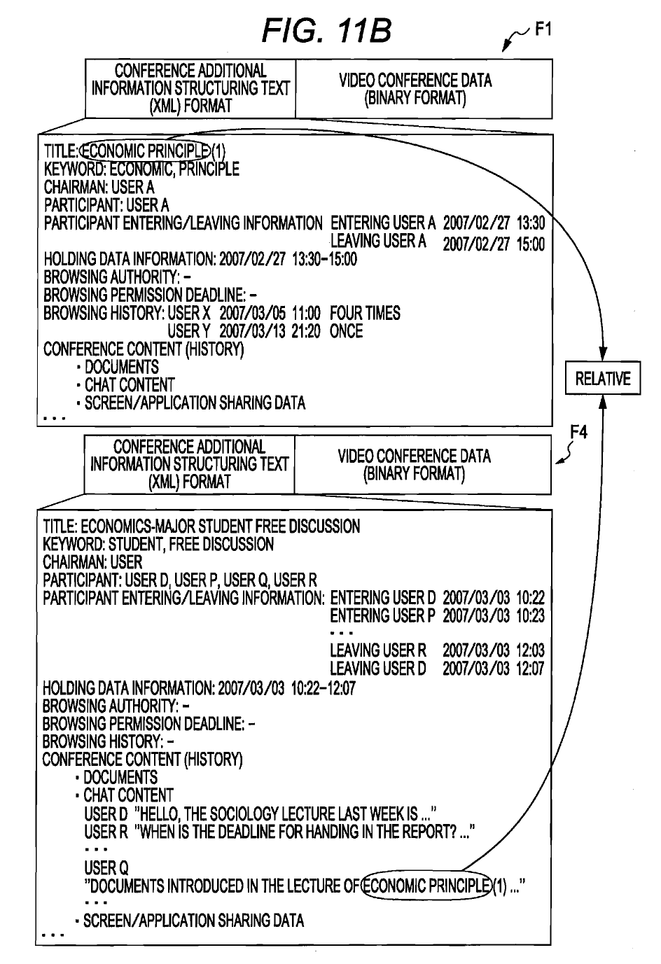

FIGS. 11A and 11B are explanatory diagrams showing specifying of a related video conference data file. Here, a case in which the acquired attribute information is “Economic Principle” will be described below. In FIG. 11A, a video conference data file F3 in which documents of a conference content includes “Economic Principle” serving as attribute information is set as a related video conference data file to the video conference data file F1. In FIG. 11B, a video conference data file F4 in which a chat content includes “Economic Principle” serving as attribute information is set as a related video conference data file to the video conference data file F1.

When the related video conference data file is to be specified, the specifying unit 1002 may check the conference additional information 301 of the video conference data file F of the conference DB 104. However, the video conference data file F which is specified once may be associated by a related information table.

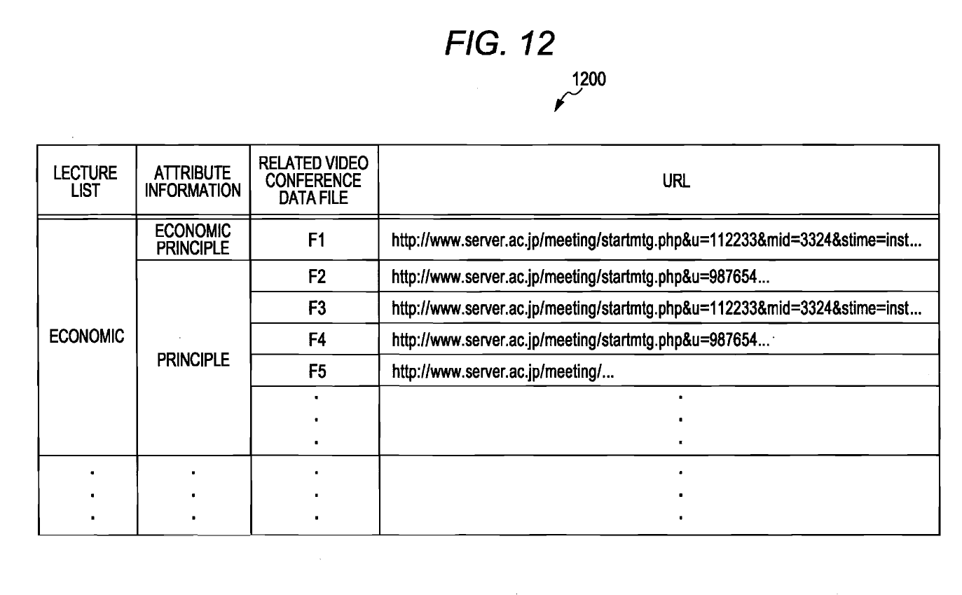

FIG. 12 is an explanatory diagram showing the related information table. In FIG. 12, a related information table 1200 is prepared for each user. In the related information table 1200, attribute information, a related video conference data file, and a URL thereof are associated with each other in each Web conference of the lecture list. For example, as shown in FIGS. 11A and 11B, when “Economic Principle” is set as the attribute information, the related video conference data files F3 and F4 are obtained. Therefore, thereafter, when the “Economic Principle” is the attribute information, the related video conference data files F3 and F4 can be specified without accessing the conference service apparatus 102. In this manner, the specifying process can be performed at a high speed.

After the related video conference data files F3 and F4 are specified, when the “Economic Principle” is the attribute information, the related video conference data files F3 and F4 are specified by the related information table 1200. For this reason, as the other video conference data files F, new video conference data files F can also be specified by searching for the conference additional information 301 of the video conference data files F of the conference DB 104. In this manner, the specifying process can be performed at a high speed, and the completeness of the related video conference data files can also be specified.

The forming unit 1003 has a function of forming link information (URL) for accessing the related video conference data file specified by the specifying unit 1002 and a start command of a new Web conference between a participant in a related Web conference related to the related video conference data file and a user.

More specifically, the link information for accessing the related video conference data file can be acquired as a URL with reference to the reference table 500 or the related information table 1200. Since a participant of the related video conference data file can be specified with reference to the conference additional information 301 of the related video conference data file, a start command to launch a new Web conference with these participants is set. This start command is a command which is transmitted to the conference service apparatus 102 to launch a new Web conference.

The generating unit 1004 has a function of embedding the link information and the start command formed by the forming unit 1003 to generate a related video conference data file and Web page information which can accept selection of a new Web conference. More specifically, Web page information is generated as data of a structuring text format which can be analyzed by a Web browser.

The transmitting unit 1005 has a function of transmitting the Web page information generated by the generating unit 1004 to the terminal device 120 of the user. The Web page information is transmitted to the terminal device 120 of a user to display the Web screen 603 shown in FIG. 8 on the terminal device 120 of the user by the Web browser. In this case, in FIG. 8, as Web conference showing the related video conference data file, in character strings “Exchange Control and Difference between Domestic and Foreign Prices in Financial Policy”, “<Practice> Thinking Technique”, and “Economics-major Student Free Discussion”, URLs to access the related video conference data files of the character strings are embedded, respectively. Therefore, when the character string is clicked, the related video conference data file is reproduced.

In FIG. 8, as the start command, a start command of a new Web conference in which each participant can participate is embedded in a character string “→Question to Participant (Participation in Conference)” added to each Web conference representing the related video conference data file. Therefore, the character string is clicked to start the conference client, so that a Web conference with the participant can be performed.

(Updating Procedure of Related Information Table 1200)

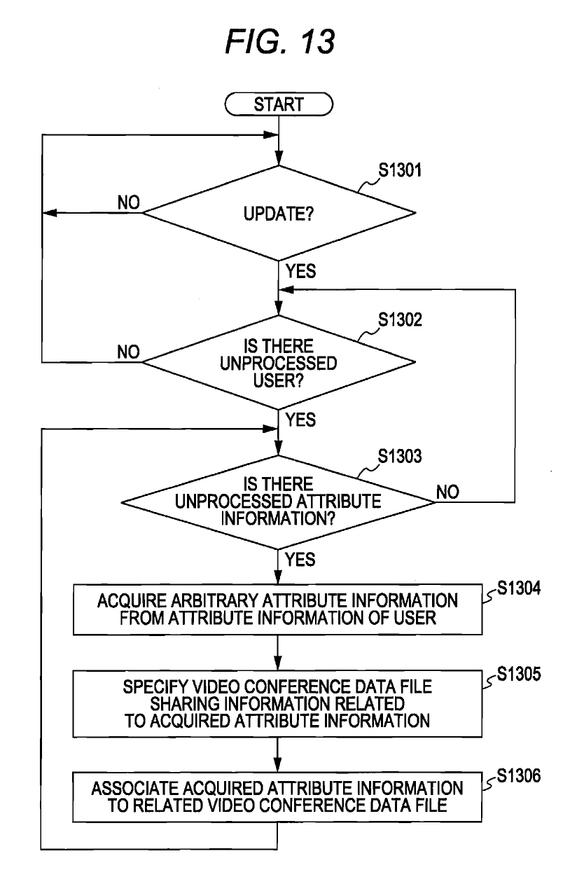

An updating procedure of the related information table 1200 will be described below. FIG. 13 is a flow chart showing the updating procedure of the related information table 1200. In FIG. 13, the acquiring unit 1001 determines whether updating is performed (S1301). This decision may be made by checking whether a predetermined period of time elapses.

When the updating is not performed (S1301: No), the acquiring unit 1001 waits until the updating is started. When the updating is performed (S1301: Yes), the acquiring unit 1001 determines whether there is an unprocessed user (S1302). When there is no unprocessed user (S1302: No), the process returns to S1301. On the other hand, when there is an unprocessed user (S1302: Yes), the acquiring unit 1001 determines whether the user has unprocessed attribute information (S1303).

When the user has no unprocessed attribute information (S1303: No), control of the process returns to S1302. On the other hand, when the user has unprocessed attribute information (S1303: Yes), the acquiring unit 1001 acquires arbitrary attribute information from the attribute information of the user (S1304). The specifying unit 1002 specifies a video conference data file having information related to the acquired attribute information (S1305) to associate the acquired attribute information with (the URL of) the related video conference data file (S1306). In this manner, the related information table 1200 is updated.

(Web Conference Support Procedure)

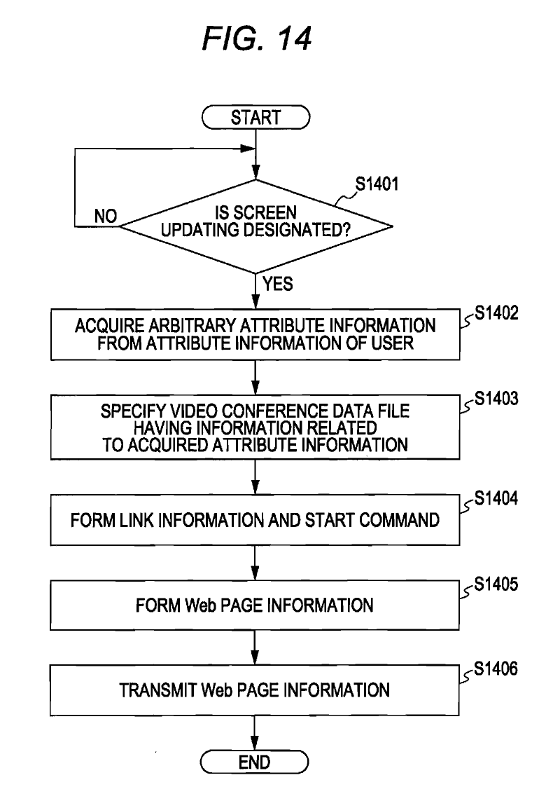

A Web conference support procedure will be described below. FIG. 14 is a flow chart showing the Web conference support procedure. In FIG. 14, the acquiring unit 1001 waits until the screen is designated to be updated, for example, a predetermined period of time elapses or screen transition is input (S1401: No), and when screen transition is designated (S1401: Yes) arbitrary attribute information is acquired from attribute information of a user (S1402).

The specifying unit 1002 specifies a video conference data file having information related to the acquired attribute information (S1403), and the forming unit 1003 forms link information to the related video conference data file and a start command of a new Web conference (S1404). The generating unit 1004 generates Web page information in which the link information and the start command are embedded (S1405) to transmit the Web page information to the terminal device 120 of the user (S1406). In this manner, a new Web conference derived from the related video conference data file is held.

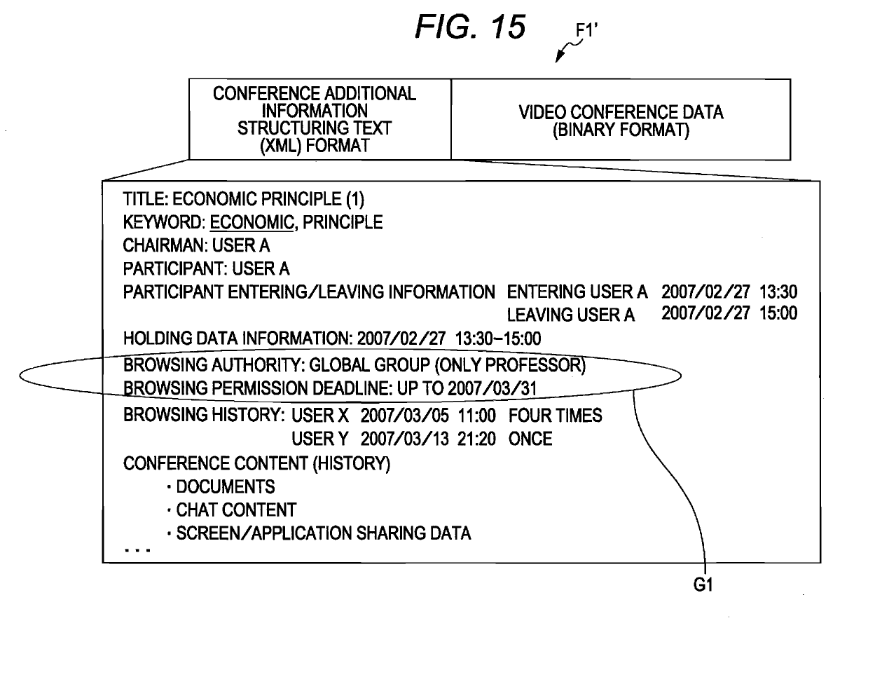

As described above, the specifying unit 1002 can filter a video conference data file of a specifying source by a browsing authority or a browsing deadline. FIG. 15 is an explanatory diagram showing a video conference data file having a browsing authority and a browsing deadline. When the specifying unit 1002 specifies a video conference data file F1′ shown in FIG. 15 as a related video conference data file, only a user having an authority to browse a new Web conference derived from the related Web conference can participate in the Web conference before the browsing deadline elapses.

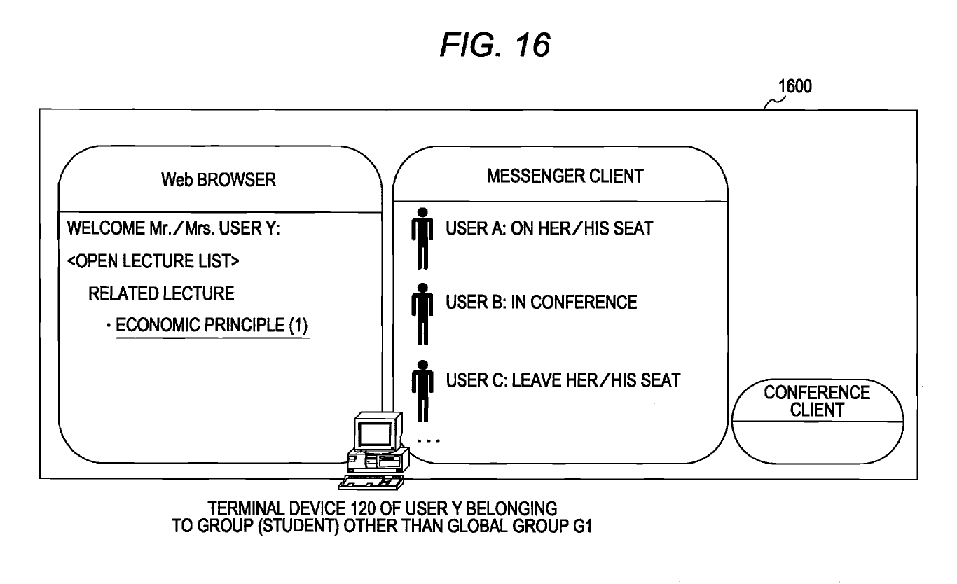

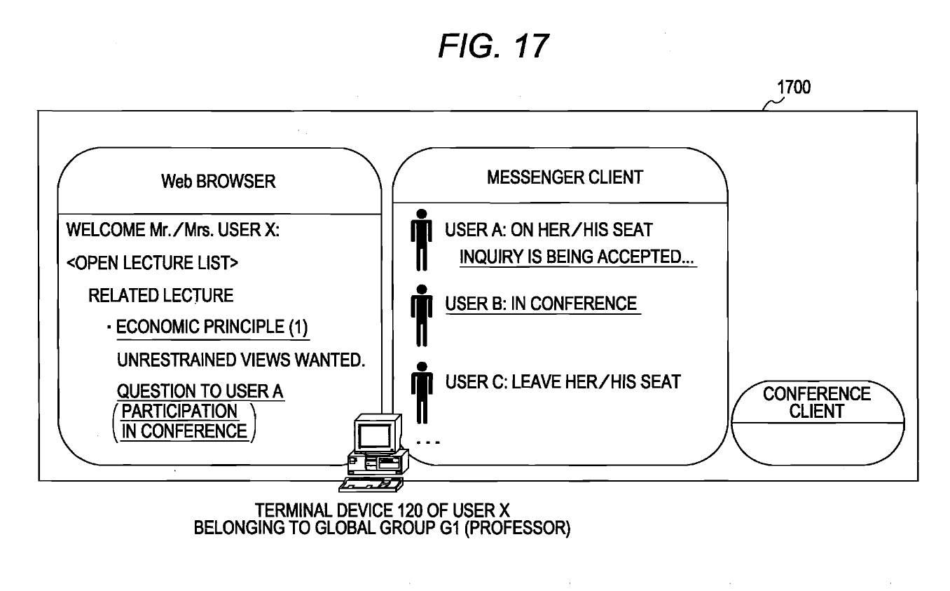

Therefore, in this case, since the user X belongs to the global group G1, the Web page information generated by the generating unit 1004 is not transmitted to the terminal device 120 of a user Y who does not belong to the global group G1. FIG. 16 is an explanatory diagram showing a display screen 1600 on the terminal device 120 of the user Y which does not belong to the global group G1. On the other hand, the Web page information is transmitted to the terminal device 120 of the user X which belongs to the global group G1. FIG. 17 is an explanatory diagram showing a display screen 1700 of the terminal device 120 of the user X which belongs to the global group G1.

In this manner, when the related video conference data file is restricted to be browsed, the same browsing restriction is automatically set to the new Web conference derived from the Web conference, and security can be improved.

In the embodiment described above, a related Web conference data file is specified by using attribute information of a user as a key, and Web page information to hold a new Web conference with the participant is generated and transmitted to the user. However, the user reproduces the video conference data file to notify the terminal device 120 of the participant (especially, a lecturer) that the user reproduces the video conference data file, so that the terminal device 120 of the user may be notified that the terminal device 120 of the participant is notified.

(Functional Configuration 2 of Web Conference Support Apparatus 103)

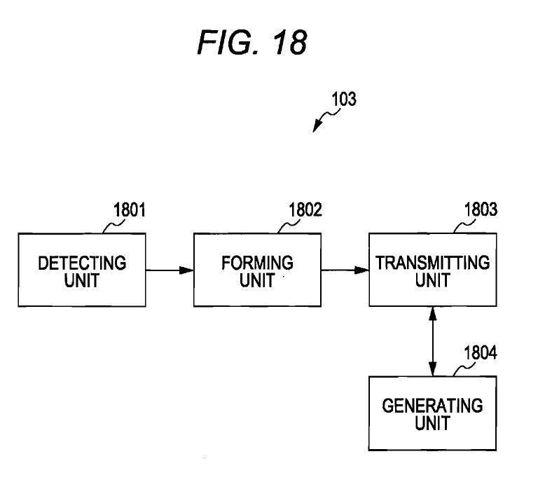

FIG. 18 is a block diagram showing a functional configuration 2 of the Web conference support apparatus according to the embodiment of the present invention. In FIG. 18, the Web conference support apparatus 103 includes a detecting unit 1801, a forming unit 1802, a transmitting unit 1803, and a generating unit 1804.

The configurations 1801 to 1804 cause the CPU to execute programs related to functions stored in the memory to realize these functions. Output data from the respective configurations are stored in the memory. A configuration to be accessed indicated by an arrow in FIG. 18 loads the output data from a source configuration from the memory and causes the CPU to execute the programs related to the function.

The detecting unit 1801 has a function of detecting updating of a browsing history by a user in the video conference data file by reproducing a video conference data file selected by a user from the Web screen 603 displayed on the terminal device 120 of the user as a result of transmission of Web page information which can accept selection of a Web conference. More specifically, for example, in the case where the Web screen 603 shown in FIG. 8 is displayed on the terminal device 120 of the user X, when the user X clicks “Economic Principle (1)”, the conference client software is started to reproduce the video conference data file of the “Economic Principle (1)”.

Upon completion of the reproduction of the video conference data file, the browsing history of the conference additional information 301 is updated by the conference service apparatus 102. When the updating in the conference service apparatus 102 is completed, the command is transmitted to the Web conference support apparatus 103. For this reason, the updating of the browsing history can be detected.

The forming unit 1802 has a function of forming a start command of a new Web conference between a participant in a Web conference related to the video conference data file in which the updating of the browsing history is detected by the detecting unit 1801 and a user. More specifically, a participant is specified from the conference additional information 301 of the video conference data file the updating of which is detected, and a start command of a new Web conference between the participant and the user is set.

The forming unit 1802 also has a function of forming a start command of a new Web conference between a participant in the Web conference related to the video conference data file in which the updating of the browsing history is detected by the detecting unit 1801 and the user. More specifically, a participant is specified from the conference additional information 301 of the video conference data file the updating of which is detected, and a start command of a new Web conference between the participant and the user is set.

For example, the start command is generated as follows.

http://aaaa.bbbb.co.jp/dddd/gotomeeting.php?

u=nn&id=mm&g=(encoded conference information)

The “gotomeeting.php” is a script which start a Web conference application described by PHP. The character string of the script is described as appropriate link information to a Web page by HTML, and a link is clicked on a Web browser to execute a start command. The “nn” denotes a number corresponding to a user account of a user. The forming unit 1802 searches the user DB 105 to acquire an SEQ (record identifier) corresponding to a user account of a user and set the SEQ as a main parameter. The “mm” is an identifier of a conference. The forming unit 1802 searches for an identifier in the conference DB 104 to acquire an SEQ (record identifier) corresponding to the identifier of the conference and set the SEQ as a main parameter. As the “encoded conference information”, a conference title, a participant name, the presence/absence of record, and the like are set. In this case, as the “conference title”, “response to posting” or the like is fixedly set. As the “participant name”, a name of a conference organizer (poster) is set. The “presence/absence of record” indicates whether a conference newly held in this time is recorded”. As the “presence/absence of record”, “record” is fixedly set.

The transmitting unit 1803 has a function of transmitting a holding notification of a new Web conference to the terminal device 120 on the basis of the start command formed by the forming unit 1802. More specifically, the start command is transmitted to the conference service apparatus 102 to cause the conference service apparatus 102 to transmit the holding notification from the presence management apparatus 101 to the terminal device 120 of the participant in cooperation with the presence management apparatus 101. When the terminal device 120 of the participant receives the holding notification, the presence screen is updated by the message client software.

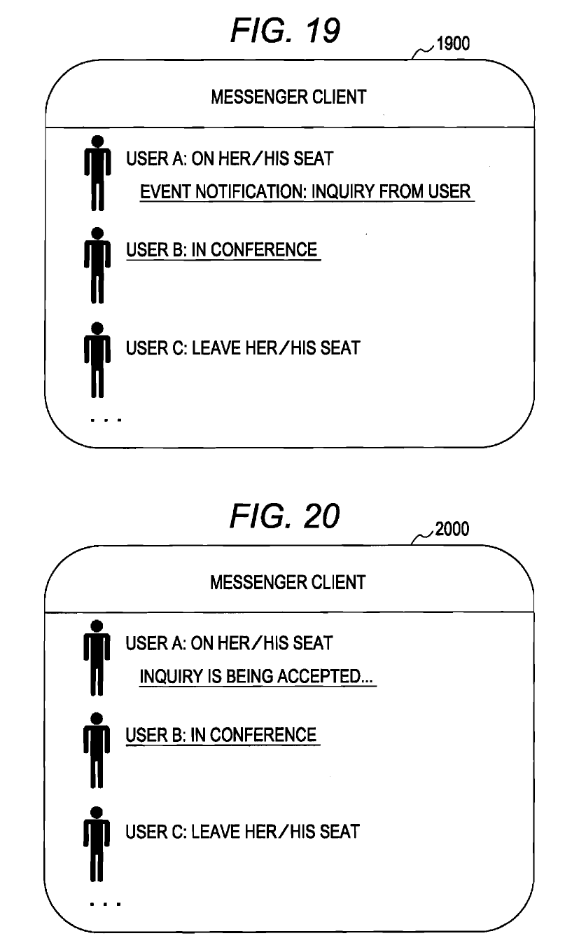

FIG. 19 is an explanatory diagram showing a presence screen obtained when the holding notification is received. FIG. 19 shows a presence screen of a user A who is a participant. On the presence screen 1900, with respect to the user A, a character string representing a holding notification “event notification: inquiry from the user X” is displayed. When the user A clicks the character string, a terminal of the user A is connected to the conference service apparatus 102, and the user A can participate in a new Web conference with user X.

FIG. 20 is an explanatory diagram showing a presence screen of the user X who is an organizer after a holding notification is transmitted. In FIG. 20, in a presence screen 2000, presence information of the user A is updated by the presence management apparatus 101 into “inquiry is being accepted”. Thereafter, when the user A participates in the Web conference, the presence information is updated into “in conference”.

The generating unit 1804 has a function of generating new Web page information obtained by adding a content representing that the start command is transmitted to the Web page information when an event notification is transmitted by the transmitting unit 1803. More specifically, when the start command is transmitted to the presence management apparatus 101, the generating unit 1804 adds the character string representing that effect to the Web page information. When the new Web page information added with the character string is transmitted to the terminal device 120 of the user X, the Web screen 603 of the user X is updated.

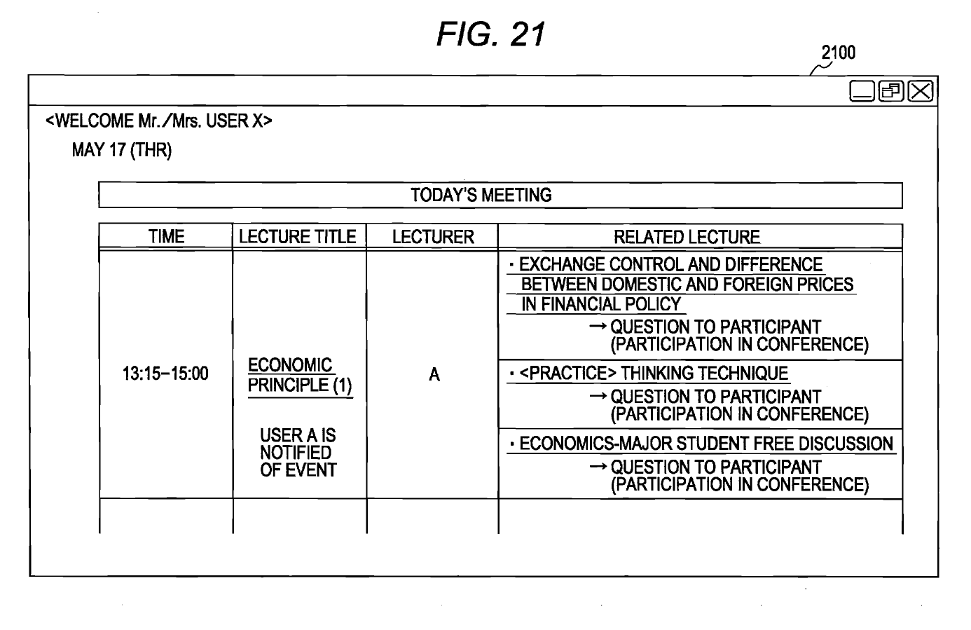

FIG. 21 is an explanatory diagram showing a new Web screen after the Web screen 603 shown in FIG. 10 is updated. In FIG. 21, on an updated Web screen 2100, a character string “user A is notified of event” representing that a holding notification of a Web conference is transmitted to the user A is added under the reproduced character string “Economic Principle (1)”.

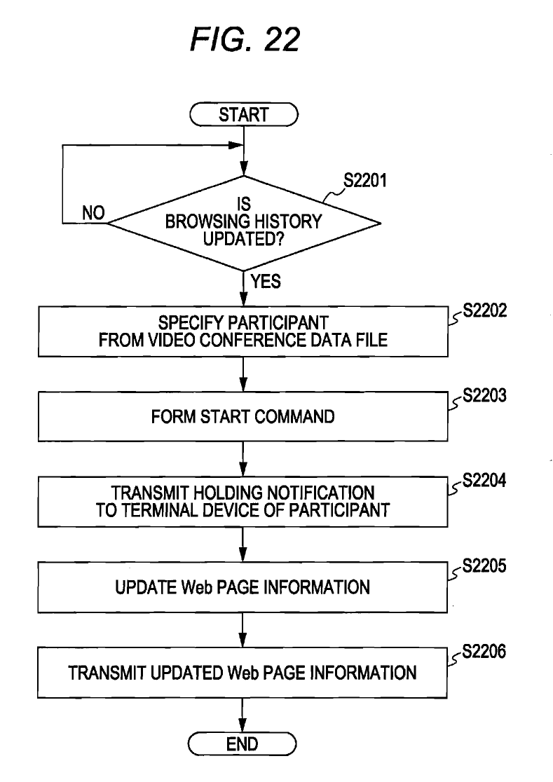

A Web conference support procedure in the functional configuration 2 of the Web conference support apparatus 103 will be described below. FIG. 22 is a flow chart showing a Web conference support procedure in the functional configuration 2 of the Web conference support apparatus 103.

In FIG. 22, when the file name of the Web screen 603 is clicked to reproduce the video conference data file by a user, the detecting unit 1801 waits until updating of the browsing history is detected (S2201: No). When the updating is detected (S2201: Yes), the participant is specified from the conference additional information 301 of the video conference data file the updating history of which is updated (S2202).

The forming unit 1802 forms a start command of a new Web conference between the user who reproduces the video conference data file and the participant (S2203). The transmitting unit 1803 transmits a holding notification to the terminal device 120 of the participant on the basis of the start command (S2204).

Thereafter, a character string representing that the holding notification has been transmitted is added to the Web page information transmitted to the user to update the Web page information (S2205). Finally, the transmitting unit 1803 transmits the Web page information obtained after the updating to the terminal device 120 of the user (S2206) to update the updated Web screen 2100 of the user. Therefore, the user knows that the holding notification has been transmitted.

In this manner, in the embodiment described above, the Web conference support apparatus 103 derives relevance between the attribute information of the user and the video conference data file and transmits information related to the relevance to the user as a new article (Web page information). In this manner, the user becomes able to derive objective relevance between a Web conference which the user attends and a Web conference which has not been noticed by the user.

Furthermore, a start command which performs event notification to hold a new Web conference is incorporated in a newly associated article, so that a user who is interested in the Web conference is able to transmit an inquiry for a related user to the user in the form of a Web conference or a video mail. In this manner, a linkage of effective information can be automatically generated.

As described above, according to the embodiment, the Web conference support apparatus 103 specifies a video conference data file related to the user in the video conference data files accumulated in a real-time collaboration apparatus (the presence management apparatus 101 and the conference service apparatus 102), so that an article (Web page information) which can hold a new Web conference with the participant of the related video conference data file can be automatically generated. In this manner, effective utilization of the accumulated video conference data files F can be realized. In addition, an appropriate browsing management, such as browsing authority or browsing deadline can be given, and a function for copyright protection can also be realized.

In this manner, deriving of relevance between articles which is not noticed by a person (user) is very effectively applied to an information transmitting device such as a business blog because the deriving can be linked to planning of an effective merchandise strategy, marketing activity, advertisement distribution, and the like.

The embodiments can be implemented in computing hardware and/or software. For example, Web conference support method described in the embodiment can be realized such that a prepared program is executed by a computer such as a personal computer or a workstation. This program is recorded on a recording medium such as a hard disk, a flexible disk, a CD-ROM, an MO, or a DVD which can be read by a computer and executed by being read by the computer from the recording medium. The program may be a transmission medium which can be distributed through the network 110 such as the Internet. Further, any combinations of the described embodiment features, functions, and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A computer readable recording medium on which a Web conference support program is recorded, wherein said Web conference support program causes a computer to execute operations comprising:
acquiring arbitrary attribute information from attribute information of a user;
specifying a related video conference data file having information related to said acquired attribute information in a set of video conference data files of a Web conference;
forming link information which accesses said related video conference data file specified by said specifying and a start command of a new Web conference between a participant in a related Web conference related to said related video conference data file and said user;
embedding said formed link information and said start command in Web page information accepting selection of said related video conference data file and said new Web conference; and
transmitting said Web page information to a terminal device of said user.

2. The computer readable recording medium on which a Web conference support program is recorded according to claim 1, wherein said acquiring acquires arbitrary attribute information from said attribute information of said user each time a display screen transition is detected in said terminal device of said user.

3. The computer readable recording medium on which a Web conference support program is recorded according to claim 1, wherein said acquiring acquires arbitrary attribute information from said attribute information of said user each time a predetermined period of time elapses.

4. The computer readable recording medium on which a Web conference support program is recorded according to claim 1, wherein the set of video conference data files of the Web conference has browsing authority information related to said acquired attribute information of the user and the specifying specifies the related video conference data file according to said browsing authority held by said user.

5. The computer readable recording medium on which a Web conference support program is recorded according to claim 1, wherein the set of video conference data files of the Web conference has browsing deadline information related to said acquired attribute information and the specifying specifies a related video conference data file for which said browsing deadline has not passed.

6. A computer readable recording medium on which a Web conference support program is recorded, wherein said Web conference support program causes a computer to execute operations comprising:
reproducing a video conference data file selected from a Web screen displayed on a terminal device of a user as a result of transmission of Web page information which can accept selection of a Web conference;
detecting updating of a browsing history by said user in said video conference data file, based upon the reproduction of the selected video conference data file;
forming a start command of a new Web conference between a participant in a Web conference related to said related video conference data file in which said updating of said browsing history is detected by said detecting unit and said user; and
transmitting a holding notification of said new Web conference on said basis of said formed start command.

7. The computer readable recording medium on which a Web conference support program is recorded according to claim 6, wherein the operations further comprise:
when said holding notification is transmitted by said transmitting, generating new Web page information by adding a content representing that said holding notification has been transmitted to said Web page information, wherein
said transmitting transmits said new Web page information to said terminal device of said user.

8. A Web conference support apparatus in communication with a terminal device of a user, comprising:
acquiring arbitrary attribute information from attribute information of the user;
specifying a related video conference data file having information related to said acquired attribute information in a set of video conference data files of a Web conference;
forming link information accessing said specified related video conference data file and a start command of a new Web conference between a participant in a related Web conference related to said related video conference data file and said user;
embedding said link information and said start command formed in Web page information accepting selection of said related video conference data file and said new Web conference; and
transmitting said Web page information to the terminal device of said user.

9. A method of supporting a Web conference by a user at a terminal device, comprising:
storing attribute information of the user;
acquiring an attribute from the attribute information of the user;
storing a set of video conference data files of Web conferences;
specifying a related video conference data file having information related to said acquired attribute, based upon the set of video conference data files of the Web conferences;
forming link information which accesses said related video conference data file and a start command of a new Web conference between a participant in a related Web conference related to said related video conference data file and said user;
embedding said formed link information and said start command in Web page information accepting selection of said related video conference data file and said new Web conference; and
transmitting said Web page information to the terminal device of said user.

10. The method of claim 9, wherein the set of video conference data files of the web conferences and/or the attribute information of the user comprise browsing management information and the specifying specifies the related video conference data file according to the browsing management information.
